(19) United States
(12) Patent Application Publication
(10) Pub. No.: US 2012/0033583 A1
(43) Pub. Date: Feb. 9, 2012

(54) Policy-Based Network and Service Domain Selection for Legacy Non-IP Telecommunication Services Over Heterogeneous Networks

(76) Inventors: Qingmin J. Hu, Sammamish, WA (US); Farooq Bari, Bothell, WA (US)

(21) Appl. No.: 12/849,433

(22) Filed: Aug. 3, 2010

(51) Int. Cl. H04L 12/28

(52) U.S. Cl. 370/254

(57) ABSTRACT

A method includes receiving, by a policy manager, a legacy service request for a terminal disposed in an access area including a plurality of networks. The method includes determining, by the policy manager, an optimal delivery network from the plurality of networks to handle the legacy service request. The method includes transmitting, by the policy manager, the legacy service request to the optimal delivery network. The method includes forwarding, by the optimal delivery network, the legacy service request to the terminal disposed in the access area.

### BACKGROUND

Current wireless networks include cellular networks such as Global System for Mobile Communications (GSM), Code Division Multiple Access 2000 (CDMA2000), Universal Mobile Telecommunications System (UMTS), etc. Developments have started in creating more advanced networks. These advanced cellular networks, otherwise known as a long term evolution (LTE) network, may include initial deployments in which a hot spot overlay is used. In addition to cellular networks, local area wireless networks such as WiFi are also being widely deployed as public and private hot spots. To improve chances of service delivery, conventional terminals support multiple technologies to leverage an underlying legacy 2G/3G network with a wider coverage area.

The LTE network is an all Internet Protocol (IP) packet switched only network. In an all IP LTE network, it may not be possible to deliver many conventional mobile telecommunication services such as SMS, circuit switched voice, etc. (i.e., legacy services) in their native form and so the devices may have to fall back to 2G/3G in order to receive a requested service or the services have to be transformed into a form that can be carried over a packet switched network. One of the key characteristics of the Third Generation Partnership Project (3GPP) core network is policy control (PCC) which manages transport resources in a packet switched (PS) domain available in LTE and legacy 2G/3G networks. However, existing PCC mechanisms are only configured to deal with IP flows. Currently, there is no uniform mechanism for network selection that also includes domain selection for legacy services.

### SUMMARY OF THE INVENTION

The exemplary embodiments describe a method comprising receiving, by a policy manager, a legacy service request for a terminal disposed in an access area including a plurality of networks. The method comprises determining, by the policy manager, an optimal delivery network from the plurality of networks to handle the legacy service request. The method comprises transmitting, by the policy manager, the legacy service request to the optimal delivery network. The method comprises forwarding, by the optimal delivery network, the legacy service request to the terminal disposed in the access area.

### DESCRIPTION OF THE DRAWINGS

FIG. 1a shows a first network disposed in an access area according to an exemplary embodiment.

FIG. 1b shows a second network disposed in the access area according to an exemplary embodiment.

FIG. 1c shows a third network disposed in the access area according to an exemplary embodiment.

FIG. 1d shows a combined network comprising the first, second, and third networks of FIGS. 1a-c disposed in the access area according to an exemplary embodiment.

FIG. 2 shows a policy server for the access area according to an exemplary embodiment.

FIG. 3 shows a process flow for a legacy service request according to an exemplary embodiment.

FIG. 4 shows a method for determining an optimal delivery network for a legacy service according to an exemplary embodiment.

FIG. 5 shows a method for providing policies to a mobile device according to an exemplary embodiment.

FIG. 6 shows a method for performing a legacy service by a mobile device according to an exemplary embodiment.

### DETAILED DESCRIPTION

The exemplary embodiments may be further understood with reference to the following description and the appended drawings, wherein like elements are referred to with the same reference numerals. The exemplary embodiments describe a device and method for managing a delivery of legacy services in an environment where multiple network types are available. The exemplary embodiments further describe managing legacy services by enhancing a policy control (PCC) architecture such as those defined in the 3GPP specifications. The multiple network types, the legacy services, a service request, and a related method will be discussed in further detail below.

It should be noted that the following description uses 2G, 3G, and LTE networks for illustrative purposes. According to the exemplary embodiments, the network may include various access networks such as CDMA2000, EVDO, WLAN, WiMAX, personal area networks (e.g., IEEE 802.15), etc. The various network types may also include IP-networks, non-IP networks, WiFi, etc. It should also be noted that the use of mobile devices in the following description is only exemplary. The network may be configured to support any electronic device whether mobile or not. Thus, any use of the term “mobile device” may also represent terminals or other end user devices.

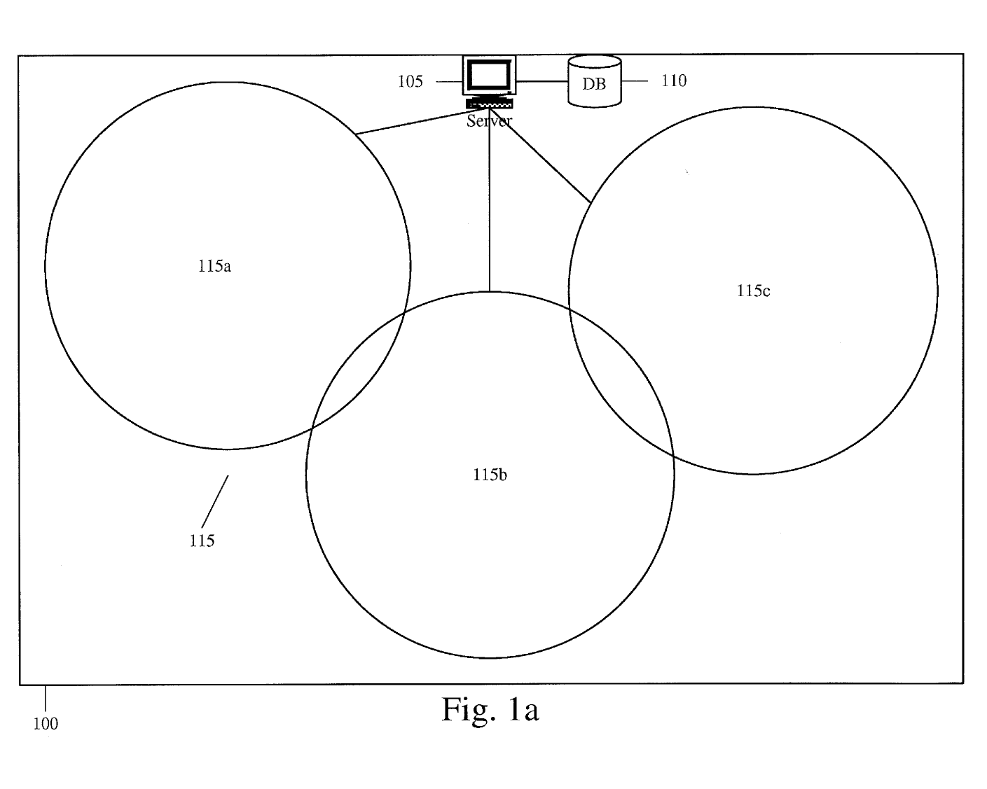

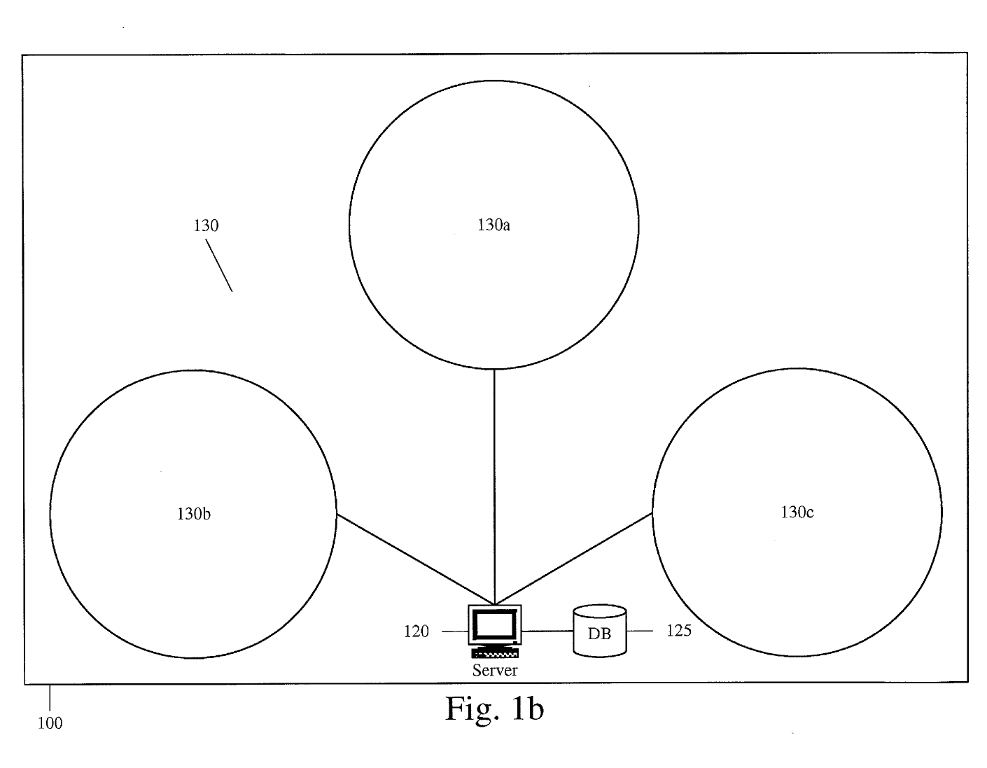

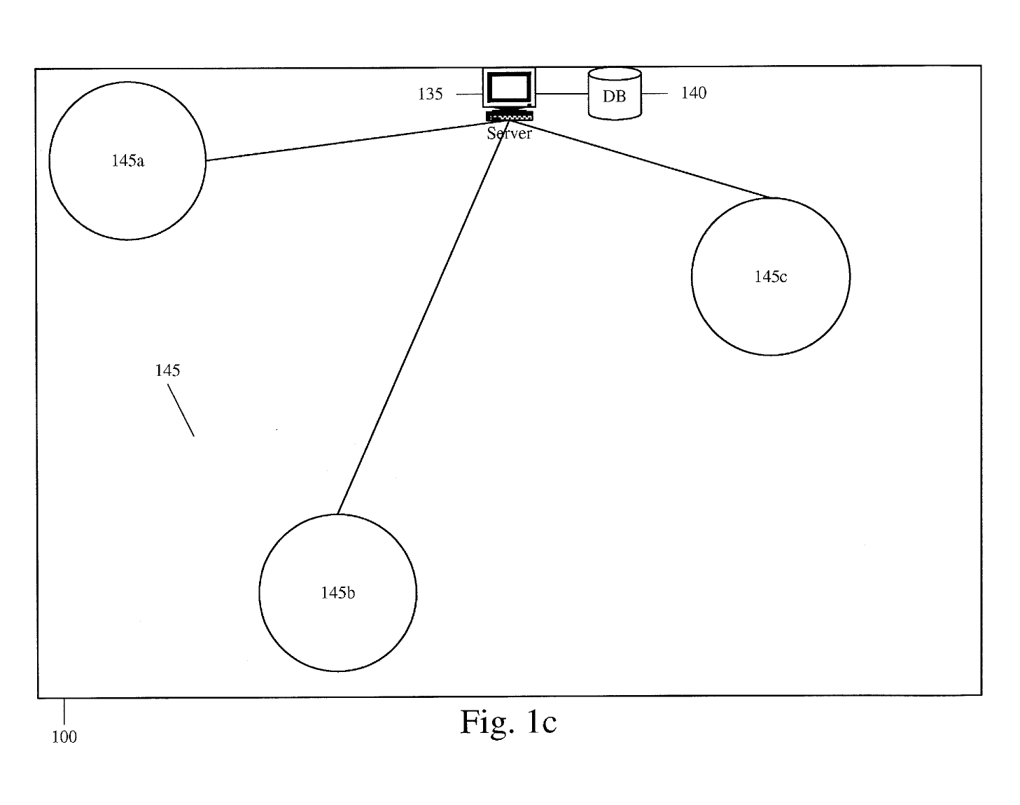

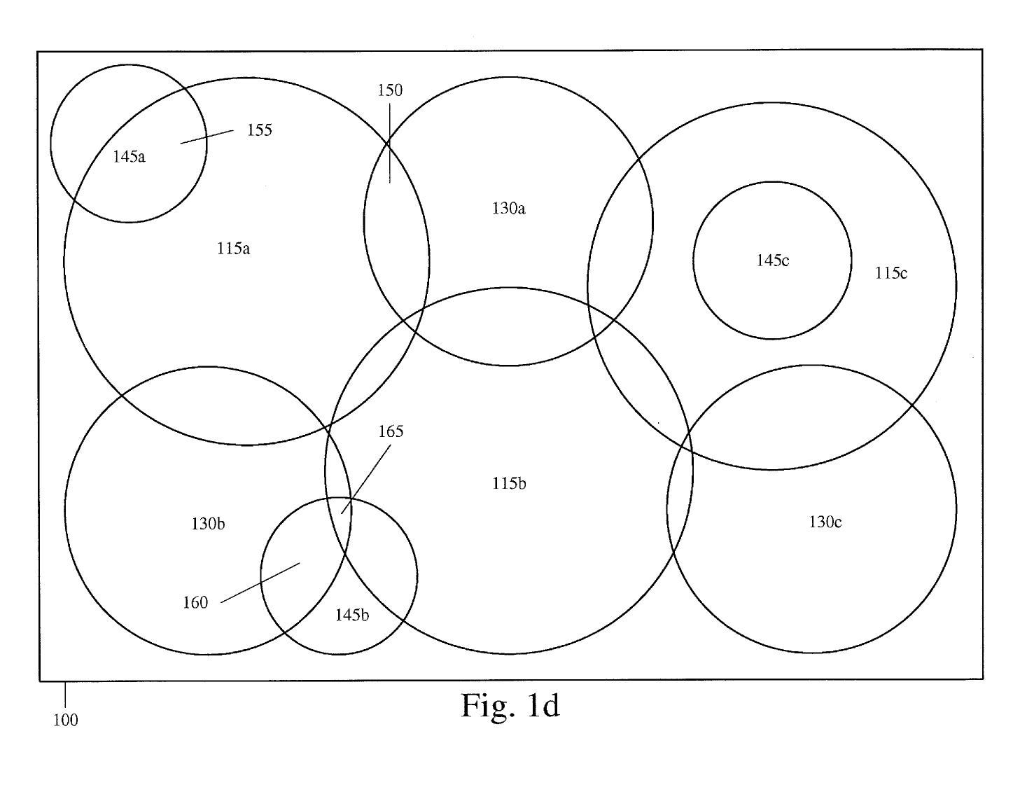

FIGS. 1a-d shows an access area 100 according to an exemplary embodiment. The access area 100 may enable mobile devices to connect to the different types of access networks available therein so that mobile services may be provided. As will be discussed in further detail below, the access area 100 may include a variety of different types of access networks including ones that are non-IP such as cellular networks, ones that are IP such as WiFi networks, etc. Thus, the mobile devices may be equipped with various radio technologies to connect to different types of networks that provide the services thereof. For example, if a mobile device is disposed in an overlapping access area so that multiple networks are accessible, the mobile device may include a transceiver or other connection component that enables the connection to one or more of the multiple networks. Also as will be discussed in further detail below, the exemplary embodiments provide a means to select a type of network to optimally deliver a requested service, in particular when relating to legacy non-IP services.

As illustrated in FIG. 1a, the access area 100 may include a first network 115 comprising coverage areas 115a, 115b, and 115c. Thus, when a mobile device is disposed within any of the coverage areas 115a-c, the mobile device may be configured to connect to the first network 115. The first network 115 may be, for example, a 2G network such as a GSM, a TDMA, a CDMA, etc. The first network 115 may include a server 105 and a database 110. The server 105 may provide conventional functionalities for the first network 115. The database 110 may also provide a conventional storage functionality for the first network 115.

As illustrated in FIG. 1b, the access area 100 may also include a second network 130 comprising coverage areas 130a, 130b, and 130c. Thus, when a mobile device is disposed within any of the coverage areas 130a-c, the mobile device may also be configured to connect to the second network 130. The second network 130 may be, for example, a 3G network such as UMTS, CDMA2000, upgraded generation CDMA/TDMA, etc. The second network 130 may also include a server 120 and a database 125 which provide substantially similar functionalities as the server 105 and the database 110, respectively.

As illustrated in FIG. 1c, the access area 100 may further include a third network 145 comprising coverage areas 145a, 145b, and 145c. Thus, when a mobile device is disposed within any of the coverage areas 145a-c, the mobile device may further be configured to connect to the third network 145. The third network 145 may be, for example, a LTE network. The third network 145 may further include a server 135 and a database 140 which provide substantially similar functionalities as the server 105 and the database 110, respectively.

It should be noted that the use of the 2G/3G/LTE networks for the first, second, and third networks is only exemplary. That is, the use of IP networks and corresponding services that may be provided is only exemplary. As discussed above, the networks disposed in the access area 100 may vary from IP networks to non-IP networks to WiFi networks to hybrid IP/non-IP networks, etc. Thus, for example, the second network 130 may be a network which is not configured to support IP services. Those skilled in the art will understand that the LTE network is an all IP network, thereby non-IP services not being configured to be supported therein.

FIG. 1d shows a combined network comprising the first network 115, the second network 130, and the third network 145 of FIGS. 1a-c, respectively, disposed in the access area 100 according to an exemplary embodiment. As discussed above, the access area 100 may include multiple access networks in which a mobile device disposed therein may be configured to connect to a corresponding network. Thus, if a mobile device is disposed in a zone where only a single network is available, the mobile device may be configured to connect thereto.

As illustrated, it is possible for the coverage area of a network to overlap with another coverage area of a different network. For example, a section 150 may represent an intersection of the coverage area 115a with the coverage area 130a. More generally, the section 150 may represent a zone where the first network 115 and the second network 130 are both available for a mobile device disposed therein. As discussed above, the mobile device may be configured to connect to multiple networks using a transceiver or other component. Thus, when the first network is 2G and the second network is 3G, the mobile device may use the transceiver to connect to either network. As discussed above, the networks may be other types. Thus, when the first network is 2G and the second network is, for example, WiFi, the mobile device may use the transceiver to connect to the 2G network while utilizing a WiFi card to connect to the WiFi network.

In another example, a section 155 may represent an intersection of the coverage area 115a with the coverage area 145a. More generally, the section 155 may represent a zone where the first network 115 and the third network 145 are both available for a mobile device disposed therein. In a further example, a section 160 may represent an intersection of the coverage area 130b with the coverage area 145b. More generally, the section 160 may represent a zone where the second network 130 and the third network 145 are both available for a mobile device disposed therein. In yet another example, a section 165 may represent an intersection of the coverage area 115b, the coverage area 130b, and the coverage area 145b. More generally, the section 165 may represent a zone where the first, second, and third networks are all available for a mobile device disposed therein.

It should be noted that, as illustrated, the access area 100 may include zones where only a single network is available for connection. It should also be noted that the access area 100 may include a coverage area for a network that is wholly disposed within a coverage area for a different network. For example, the coverage area 145c is wholly disposed within the coverage area 115c. Thus, if a mobile device is disposed within any part of the coverage area 145c, the mobile device may be able to connect to either network 115 or the network 145.

The access area 100 may include hot spots of the LTE network. Specifically, as illustrated in FIG. 1d, an underlying 2G/3G network may be disposed in the access area 100 with LTE hot spots disposed therein. It should again be noted that the access area 100 may include the other types of networks discussed above as well with corresponding network components.

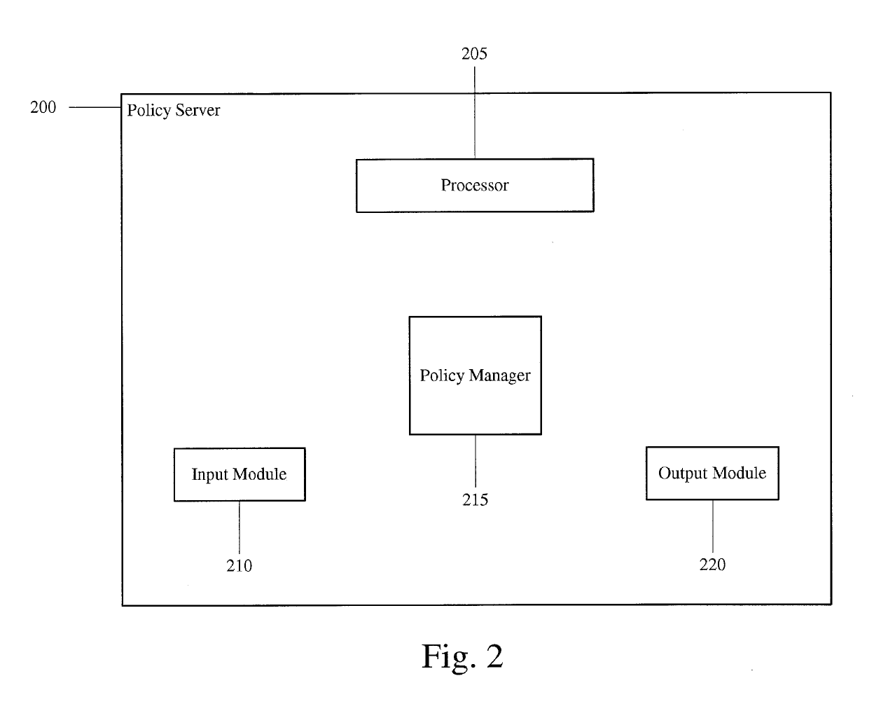

FIG. 2 shows a policy server 200 for the access area 100 according to an exemplary embodiment. As discussed above, the servers 105, 120, 135 may provide conventional functionalities such as transport resource reservation. Each network 115, 130, 145 may include a policy server including a policy manager. The policy server 200 may be disposed in at least one of the servers 105, 120, 135. For example, the policy server 200 may be part of a home server for a mobile device (e.g., when the mobile device is disposed in network 115 and establishes the server 105 as its home server). However, those skilled in the art will understand that the policy server 200 may be a separate network component or part of any other network component. It should be noted that regardless of its disposition, the policy server 200 may be configured to interact with other networks and/or other policy servers 200 to execute its functionalities.

The following description of the policy server 200 will focus on the aspects provided by the exemplary embodiments. In particular, given the infrastructure of the access area 100, the policy server 200 may determine an optimal delivery network in which a requested legacy service is to be provided. The server 200 may include a processor 205, an input module 210, a policy manager 215, and an output module 220.

The processor 205 may execute various functionalities, in particular, processing of requests for legacy services so that an optimal network type is selected to deliver the requested legacy service. According to the exemplary embodiments, the processor 205 may receive the legacy service request from the input module 210. The input module 210 may have access to the servers 105, 120, 135 so that when the legacy service request is received, it may be forwarded thereby.

As described above, the policy server 200 including the components therein may also have access to data of other network elements such as the databases 110, 125, 140. According to the exemplary embodiments, the other network elements may store the policies and parameters which serve as a basis to determine an optimal delivery network for the legacy service request. The other network elements may represent any network component that may provide data relating to determining the optimal delivery network. For example, the other network elements may also encompass operator databases, home subscriber server (HSS), real time databases, etc. or network devices such as routers, network management arrangements (NMA), signal enhancers, transmission stations, etc.

The processor 205 may forward the legacy service request to the policy manager 215. It should be noted that, as illustrated, the policy manager 215 is disposed within the policy server 200. That is, the policy manager 215 is incorporated therein. However, in another exemplary embodiment, the policy manager 215 may be a module that connects to the policy server 200 (e.g., via a universal bus connector, wireless connector such as RF and/or IR, etc.). The policy manager 215 may access the other network sources to determine the optimal delivery network.

It should be noted that the use of the policy server 200 including the policy manager 215 is only exemplary. In another exemplary embodiment, any combination of the servers 105, 120, 135 may be configured with a policy manager. In such an exemplary embodiment, the server configured with the policy manager may receive data from the other servers to determine the optimal delivery network.

The policy manager 215 may manage the delivery of legacy non-IP flow type of services in an environment where multiple coverage is provided by various network types (e.g., 2G, 3G, LTE, etc.). In an overlay 2G/3G/LTE network such as the access area 100 illustrated in FIG. 1d, decisions are constantly made as to which network best serves a particular service request, in particular legacy services such as SMS, voice, etc. where a more current network such as LTE is optimal for IP services. To provide the optimal selection of the delivery of a service request, the policy manager 215 utilizes a policy control which influences service delivery. The selection of the delivery includes an analysis of a variety of factors. According to the exemplary embodiments, the policy manager 215 accesses the other network sources such as the databases 110, 125, 140 which may store data relating to the respective network. The other network sources also include other data such as user subscription (e.g., user rate plan and costs), user preference, device capabilities, network capabilities and/or conditions, coverage area, existing network attachments, existing/ongoing services/IP sessions, best experience based on service latency and other parameters, operator policies (e.g., home and visited networks), etc.

For example, if a mobile device is disposed in both the LTE network and the 2G network such as within zone 155, the SMS services may be delivered via a legacy network such as the underlying 2G network 115 via the coverage area 115a. However, policies based on factors such as network load on different access technologies, a type of device (e.g., M2M, M to human, etc.), additional services that are being used by the device at the time, availability of the services on the machines, user preferences, etc. may be used to determine which will be the optimal network to deliver the requested SMS service. For example, if the user of the mobile device disposed in the zone 155 is registered and subscribed with the LTE network 145, the policy manager 215 may redirect or adapt the data package for the requested service into a form compatible with the LTE network. Thus, if the requested legacy service is SMS and since SMS is a non-IP service, the SMS may be converted into an IP format as the LTE network is configured for IP only.

Once the optimal delivery network has been selected by the policy manager 215, the legacy service request may be forwarded to the appropriate delivery network via the output module 220. As discussed above, the optimal delivery service may include a redirecting service. That is, in a case where the policy manager 215 determines that service data for the legacy service to be forwarded to the optimal delivery service is in an incompatible format, the service data may be redirected to an appropriate service that reformats the service data into a compatible format. In another example, the requested service may only be provided in a network in which the mobile device is not disposed. In such a case, the policy manager 215 may redirect the service data to a storage component to be delivered at a later time. For example, if the requested legacy service is a store-and-forward type service such as SMS, the service data may be stored in the database 110 so that when the mobile device connects to the network 115, the service may be provided.

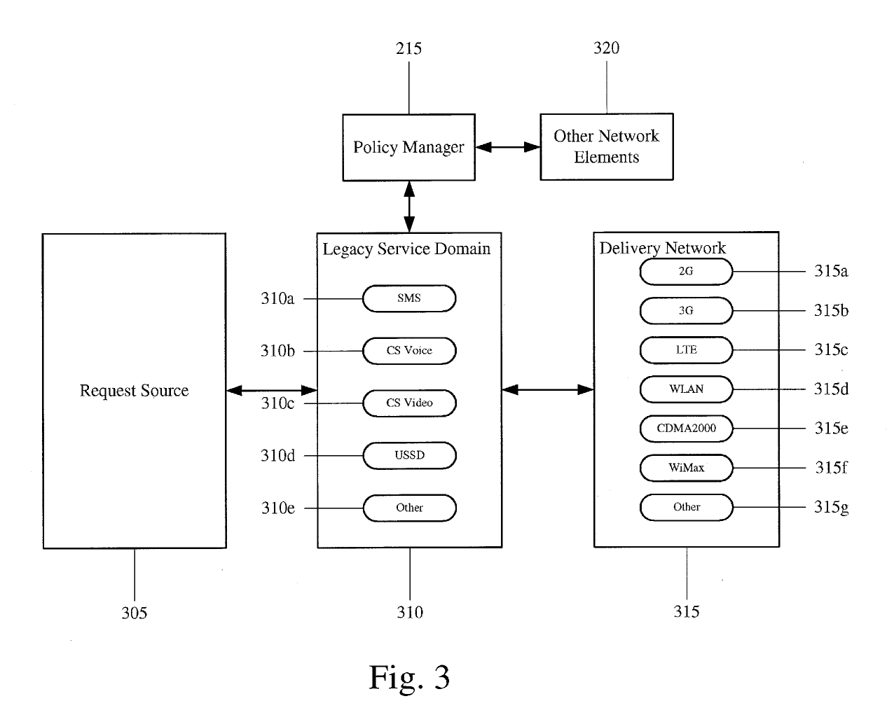

FIG. 3 shows a process flow for a legacy service request according to an exemplary embodiment. The process flow may represent a constructive view of the components involved to provide a requested legacy service given a network infrastructure. The process flow will be discussed with reference to the access area 100 of FIGS. 1a-d and the policy server 200 of FIG. 2.

The process flow may start from a request source 305. The request source 305 may be, for example, a mobile unit disposed within the access area 100 of FIGS. 1a-d. In a first exemplary scenario where the policy manager 215 determines an optimal delivery network for a legacy service request, the request source 305 forwards a legacy service request including service data to a service domain 310 representing at least one of the networks in which the mobile device is disposed therein. For example, if the mobile device is disposed in the zone 150, the service domain 310 may be the network 115 or the network 130. Thus, if the service domain 310 is the network 130 which represents a 3G network, the legacy services that may be available may include, for example, a SMS 310a, a circuit switch (CS) voice service 310b, a CS video service 310c, an unstructured supplementary service data (USSD) service 310d, or other services 310e.

The legacy service request may subsequently be forwarded to the policy manager 215. As discussed above, the policy manager 215 determines the optimal delivery network which is optimal for providing the requested legacy service. The policy manager 215 accesses the other network components 320 which may include any and all data such as user profiles stored in a subscriber profile repository (SPR), network data, rules to determine the optimal delivery network, operator databases, HSS, real-time databases, etc.

Upon determining which delivery network is optimal for the requested legacy service, the policy manager 215 forwards the response back to the service domain 310. The policy manager 215 may include instructions or may be configured to package the requested service in a format appropriate for the optimal delivery network. For example, if the service data is already in a compatible format for the selected optimal delivery network, the policy manager 215 maintains the format for the delivery. In another example, if the service data is in an incompatible format, the policy manager redirects the service data to a network component that reconfigures the service data into a compatible format for the selected optimal delivery network. In yet another example, the instructions for the delivery may be to store the service data for the requested legacy service for a delivery at a later time (e.g., when the terminal to which the legacy service is to be provided is not connected to the optimal delivery network).

The service domain 310 subsequently forwards the service data for the requested legacy service to the optimal delivery network 315 (e.g., 2G 315a, 3G 315b, LTE 315c, WLAN 315d, CDMA2000 315e, WiMax 315f, other 315g). The service domain 310 may additionally forward the response to the request source 305 to inform the source of the selected optimal delivery network. It should be noted that the automatic connection to the delivery network 315 is only exemplary. In another exemplary embodiment, the determination may be forwarded by the service domain 310 to the request source 305, thereupon the request source 305 may manually accept or decline the connection to the optimal delivery network 315 for performance of the requested legacy service.

In a second exemplary scenario where the mobile device stores policies to determine the optimal delivery network for legacy services, the policy manager 215 may be configured to provide data to the mobile device so that a requested legacy service may be processed by the mobile device.

Initially, the mobile device invokes the policy manager 215. The invoking may be performed at a variety of different times. For example, when the mobile device enters the access area 100 and connects to any of the networks disposed therein, the mobile device may automatically invoke the policy manager 215. In another example, the mobile device may connect to a network within the access area 100 and when a legacy service is requested, the policy manger 215 may be invoked.

Once invoked, the policy manager 215 performs various functionalities to determine the policies regarding the performance of legacy services available to the mobile device. For example, the policy manager 215 may receive data from one of the home server of the mobile device relating to an identity of the user, predetermined settings of the mobile device/user, capabilities of the mobile device, etc. The policy manager 215 may also use the various signal transmitters and/or network capabilities of the networks to determine a location of the mobile device. The data relating to the mobile device may also enable the policy manager to become aware of factors such as the mobile device capabilities, user subscription, network type availability, etc. Upon processing the data relating to the mobile device, the policy manager 215 may determine the policies regarding a delivery procedure for the various legacy services capable or available to the mobile device such as an optimal delivery network for a particular legacy service. It should be noted that the policy manager 215 may track the mobile device in real time so that as the mobile device moves within the access area 100, the mobile device may receive updated policies from the policy manager 215 that reflects the changes occurring to the mobile device. Thus, once the policy manager 215 determines the policies for the mobile device, the policies may be forwarded and stored on the mobile device.

Therefore, in the second exemplary scenario, the mobile device may be configured with the policies determined by the policy manager 215 to perform legacy services as desired using an optimal delivery network. When the mobile device is to perform a legacy service, the policies are used to determine the optimal delivery network. The policies may also indicate the proper format for the service data of the legacy service. Thus, if the service data of the legacy service is compatible with the selected optimal delivery network, the legacy service is performed. However, if the service data of the legacy service is incompatible with the optimal delivery network, the mobile device may forward the service data to the service domain 310 so that the service data is redirected to convert the service data to a compatible format. The mobile device may also include instructions for the service data to be stored at the optimal delivery network when the terminal to which the service data is to be sent is not connected thereto.

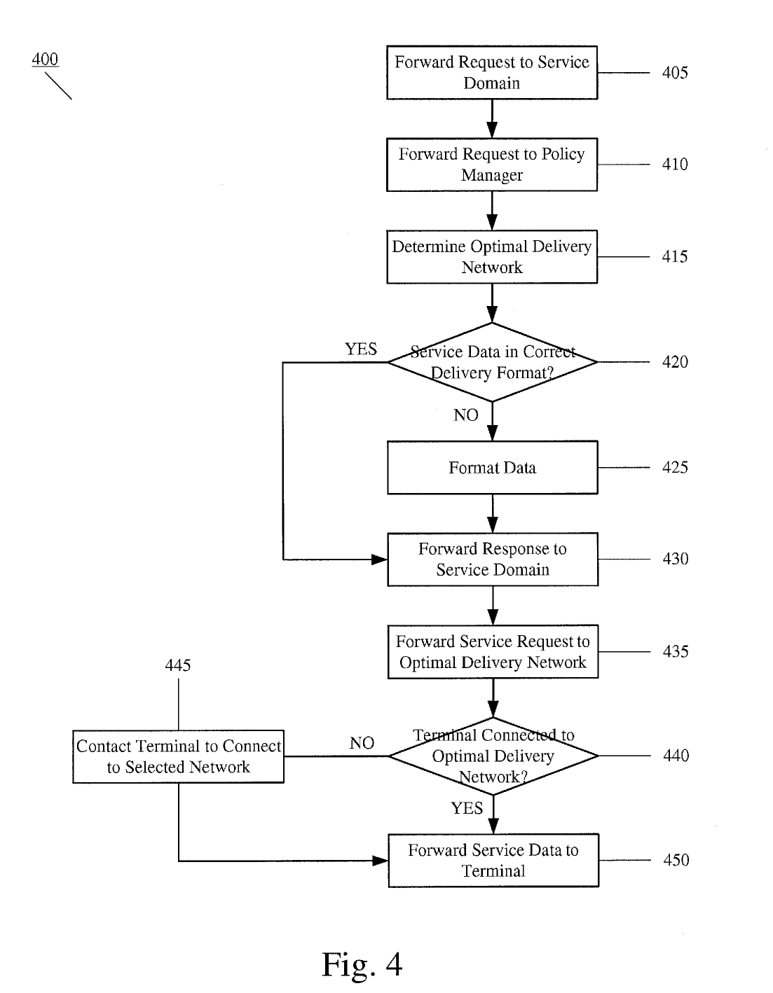

FIG. 4 shows a method 400 for determining an optimal delivery network for a legacy service according to an exemplary embodiment. Specifically, the method 400 relates to when the policy manager 215 determines the optimal delivery network. The method 400 will be described with reference to the access area 100 of FIGS. 1a-d, the policy server 200 of FIG. 2, and the first exemplary embodiment of the process flow of FIG. 3.

In step 405, the request source 305 forwards a legacy service request to the service domain 310. As described above, the service domain 310 may be the network in which the request source 305 is disposed. Thus, if the request source 305 is a mobile device disposed in the zone 155, the service domain 310 may be either network 115 or network 145. In step 410, the legacy service request is forwarded to the policy manager 215.

In step 415, the policy manager 215 determines an optimal delivery network for the requested legacy service. As described above, various parameters are considered in determining the optimal delivery network. Thus, for example, when the requested legacy service relates to a non-IP legacy service such as SMS, the policy manager 215 determines that the LTE network is not configured to perform the requested service. Thus, the policy manager 215 may determine that the underlying 2G network 115 is the optimal delivery network. However, if the policy manager 215 has data relating to the user subscription or other relevant data such as network load on the 2G network, then the policy manager 215 may adapt the data for packaging into a compatible format so that the SMS is delivered via the LTE network.

In step 420, the policy manager 215 determines whether the service data for the requested legacy service is in a correct format. For example, if the optimal delivery network is an all IP network (e.g., LTE) but the mobile device is disposed in a non-IP network, the data may not be properly configured to be delivered using the indicated optimal delivery network. Thus, if the data is properly formatted, the method 400 continues to step 430. If the data is not properly formatted, the method 400 continues to step 425 where the data is formatted. As discussed above, the formatting of the data may be performed by the policy manager 215 if configured to do so. The policy manager 215 may also redirect the data to another network component for the packaging of the data.

In step 430, the response is forwarded by the policy manager 215 back to the service domain 310. When the service domain 310 receives the response, the service domain 310 may be configured to forward the service request to the optimal delivery network (step 435). In step 440, a determination is made whether the terminal which is to be provided the service request is connected to the optimal delivery network. For example, if the terminal is disposed in an area where the optimal delivery network is incapable of transmitting the service data, the service cannot be provided. If the terminal is not connected to the optimal delivery network, the method 400 continues to step 445, where an indication is sent to the terminal to connect to the optimal delivery network to receive the service data. Once the terminal is connected to the optimal delivery network, the service data is transmitted to the terminal.

It should be noted that the method 400 may include an additional determination after step 445 in which a verification is performed to ensure that the terminal is connected to the optimal delivery network. If the terminal is still not connected to the optimal delivery network, the method 400 may include a further step in which the policy manager 215 sends the service data to the optimal delivery network with instructions for the service data to be stored for a later delivery.

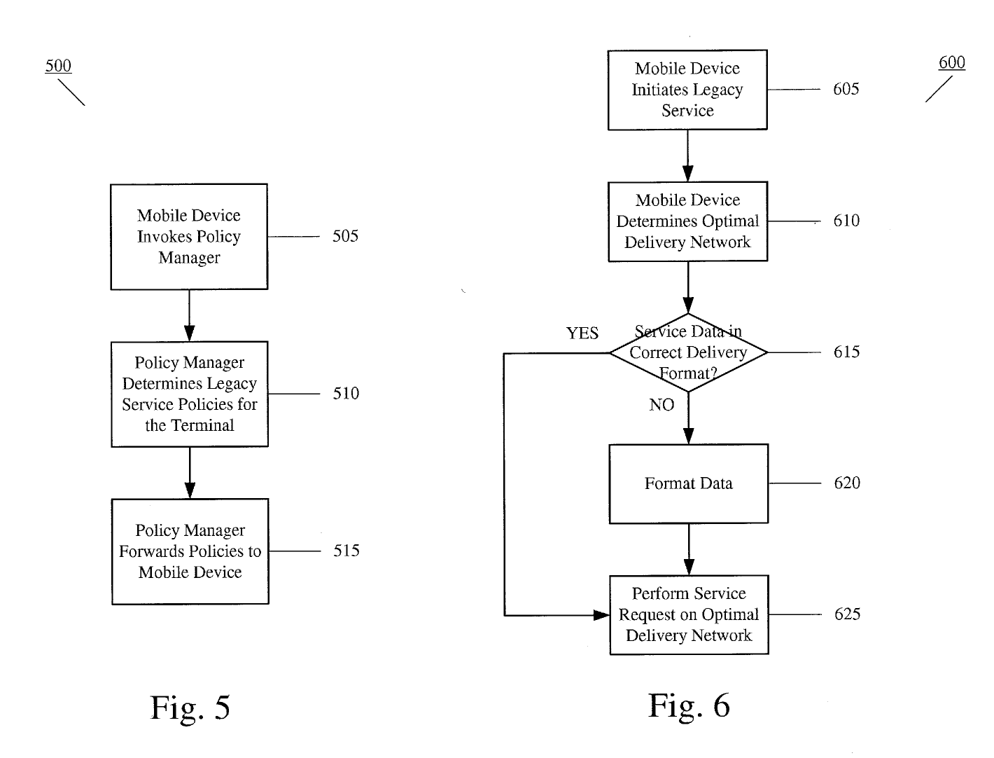

FIG. 5 shows a method 500 for providing legacy service policies to a mobile device according to an exemplary embodiment. Specifically, the method 500 relates to when the mobile device is configured to determine the optimal delivery network. That is, the method 500 relates to an initial step to provide the mobile device with the legacy service policies prior to performing a legacy service. The method 500 will be described with reference to the access area 100 of FIGS. 1a-d, the policy server 200 of FIG. 2, and the second exemplary embodiment of the process flow of FIG. 3.

In step 505, the mobile device invokes the policy manager 215. When the mobile device is connected to a network in the access area 100, the mobile device may invoke the policy manager 215 of the network. As discussed above, the policy manager 215 is invoked at a variety of times such as automatically upon the mobile device connecting to the network.

In step 510, the policy manager 215 determines the legacy service policies respective to the mobile device that invokes the policy manager 215. As discussed above, the policy manager 215 may consider a wide variety of different factors to determine the legacy service policies for the mobile device. For example, the policy manager may access the other network elements 320 for legacy service transmission information that relates to the mobile device.

In step 515, the policy manager 215 forwards the legacy service policies to the mobile device. It should be noted that, as discussed above, the policy manager 215 may continually track the mobile device to provide updated policies in a real time basis.

FIG. 6 shows a method 600 for performing a legacy service by a mobile device according to an exemplary embodiment. Therefore, the method 600 also relates to when the mobile device received the legacy service policies as described in the method 500 of FIG. 5 and is configured to determine the optimal delivery network. The method 600 will be described with respect to a mobile device disposed in the access area 100. The method 600 will be described with reference to the access area 100 of FIGS. 1a-d, the server 170 of FIG. 2, and the second exemplary embodiment of the process flow of FIG. 3.

In step 605, the mobile device initiates a legacy service such as those listed above. In step 610, the mobile device accesses the stored legacy service policies to determine the optimal delivery network to perform the legacy service.

In step 615, the mobile device may determine whether the correct format is being used for the service data of the legacy service as a function of the optimal delivery network. If the mobile device is configured to properly format the service data, the mobile device may perform the conversion. If the mobile device is not configured to format the service data, the mobile device forwards the service data to the service domain 310 and/or the policy manager 215 to redirect the service data to be properly configured into a compatible format (step 620). In step 625, once the data is in the proper format, the legacy service may be performed.

The exemplary embodiments provide a method to select an optimal delivery network for a legacy service request. A deployment of the LTE network may be a hotspot overlay with underlying legacy 2G/3G networks. When an overlap of network types are provided for an access area, a decision is made to determine which network type best suits the legacy service request. The policy manager may access various network elements including data that influences the selection process. The policy manager may consider a variety of factors such as user related factors, provider related factors, ad hoc sessions factors, etc.

According to the exemplary embodiments, when a selection of the optimal delivery network is made by the policy manager or the mobile device, a use of the networks may be optimized to improve a user experience. The use of the different network types may also leverage existing network infrastructure. The policy manager provides for a central management of services and network resources, thereby decreasing an overall resource usage. The policy manager also provides a mechanism to seamlessly manage services across multiple access technologies. The interconnection of the networks with the various network types also enable access to different network capabilities across the multiple networks.

Those skilled in the art will understand that the above described exemplary embodiments may be implemented in any number of manners, including, as a separate software module, as a combination of hardware and software, etc. For example, the policy manager 215 may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving, by a policy manager, a legacy service request for a terminal disposed in an access area including a plurality of networks;
determining, by the policy manager, an optimal delivery network from the plurality of networks to handle the legacy service request;
transmitting, by the policy manager, the legacy service request to the optimal delivery network; and
forwarding, by the optimal delivery network, the legacy service request to the terminal disposed in the access area.

2. The method of claim 1, wherein the determination is based upon at least one of a network load of each of the plurality of networks, a network condition, a coverage area of each of the plurality of networks, an existing network attachment, an existing session, a best experience basis, operator policies, a user subscription, a user preference, and parameters of the terminal.

3. The method of claim 1, wherein the plurality of networks includes a 2G network, a 3G network, a long term evolution (LTE) network, a wireless local area network (WLAN), a Code Division Multiple Access 2000 (CDMA 2000), and a WiMax network.

4. The method of claim 1, wherein the legacy service request includes service data.

5. The method of claim 4, wherein when the service data is incompatible with the optimal delivery network, the method further comprises:
redirecting the service data to a network component to configure the service data into a compatible format.

6. The method of claim 5, wherein the optimal delivery network is one of an Internet protocol (IP) network and a non-IP legacy network.

7. The method of claim 1, wherein when the terminal is not connected to the optimal delivery network, the method further comprises:
transmitting a message to the terminal requesting a connection to the optimal delivery network.

8. The method of claim 7, further comprising:
storing the legacy service request prior to transmitting until the terminal is connected to the optimal delivery network.

9. The method of claim 8, wherein the legacy service is a store-and-forward type service.

10. A method, comprising:
determining, by a service request originating terminal, an optimal delivery network from a plurality of networks of an access area to handle a legacy service as a function of policies determined by a policy manager;
transmitting, by the terminal, the legacy service to the optimal delivery network.

11. The method of claim 10, further comprising:
prior to the determining, forwarding, by the policy manager, the policies to the terminal.

12. The method of claim 11, further comprising:
prior to the forwarding, invoking the policy manager by the terminal.

13. The method of claim 12, wherein the invoking occurs at least one of automatically, manually, upon connection to one of the plurality of networks, and upon a selection of the legacy service.

14. The method of claim 10, wherein the policies are based upon at least one of a network load of each of the plurality of networks, a network condition, a coverage area of each of the plurality of networks, an existing network attachment, an existing session, a best experience basis, operator policies, a user subscription, a user preference, and parameters of the terminal.

15. The method of claim 10, wherein the plurality of networks includes a 2G network, a 3G network, a long term evolution (LTE) network, a wireless local area network (WLAN), a Code Division Multiple Access 2000 (CDMA 2000), and a WiMax network.

16. The method of claim 10, wherein the legacy service includes service data.

17. The method of claim 16, wherein the service data is incompatible with the optimal delivery network, the method further comprises:
redirecting, by the terminal, the service data to a network component to configure the service data into a compatible format.

18. A policy management device for an access area including a plurality of networks, comprising:
an input module receiving a legacy service request for a terminal disposed in the access area;
a processor determining an optimal delivery network from the plurality of networks to handle the legacy service request;
an output module transmitting the legacy service request to the optimal delivery network that forwards the legacy service request to the terminal.

19. The policy management device of claim 18, wherein the input module further receives network data from other network components relating to at least one of the plurality of networks and the terminal.

20. The policy management device of claim 19, wherein the network data includes at least one of a network load of each of the plurality of networks, a network condition, a coverage area of each of the plurality of networks, an existing network attachment, an existing session, a best experience basis, operator policies, a user subscription, a user preference, and parameters of the terminal.
